(19) United States
(12) Patent Application Publication
(10) Pub. No.: US 2012/0250238 A1
(43) Pub. Date: Oct. 4, 2012

(54) COMPUTER DESK ASSEMBLY WITH INTEGRATED DISPLAY

(75) Inventor: XIANG CAO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/220,819

(22) Filed: Aug. 30, 2011

(30) Foreign Application Priority Data
Mar. 31, 2011 (CN) 201110080355.2

(51) Int. Cl. G06F 1/16

(52) U.S. Cl. 361/679.21

(57) ABSTRACT

A computer desk assembly includes a desk and a display. The desk defines a receiving space in a top thereof. The receiving space is bounded with four side walls. The display pivotably connects with two opposite side walls of the desk. When the computer desk assembly is in a first state, a backside of the display faces upwards and the backside is coplanar with a desktop of the desk; and when the computer desk assembly is in a second state, the display is rotated relative to the desk to face upwards and ready for use.

### BACKGROUND

1. Technical Field

The disclosure relates to computer desk assemblies, and particularly to a computer desk assembly with a built-in touch screen display.

2. Description of the Related Art

A computer with its many peripherals, such as keyboards, mouse, etc., takes up a lot of real estate on a person's workdesk. A user would have to go to considerable trouble to move around their computer and/or the various peripherals to make room for the other activities such as reading or writing.

What is desired, therefore, is a computer desk assembly which can overcome the above-described shortcomings.

### BRIEF DESCRIPTION OF THE DRAWINGS

FIG. 1 is a schematic, isometric, assembled view of a computer desk assembly in accordance with a first embodiment of the disclosure in a first state.

FIG. 2 is an exploded view of the computer desk assembly of FIG. 1.

FIG. 3 is a view similar FIG. 1, but showing a display of the computer desk assembly rotated into view.

FIG. 4 is an assembled view of the computer desk assembly of FIG. 1, but showing the computer desk assembly in a second state with the display positioned for use.

FIG. 5 is an assembled view of a computer desk assembly in accordance with a second embodiment of the disclosure.

### DETAILED DESCRIPTION

Reference will now be made to the drawing figures to describe the present electronic device in detail.

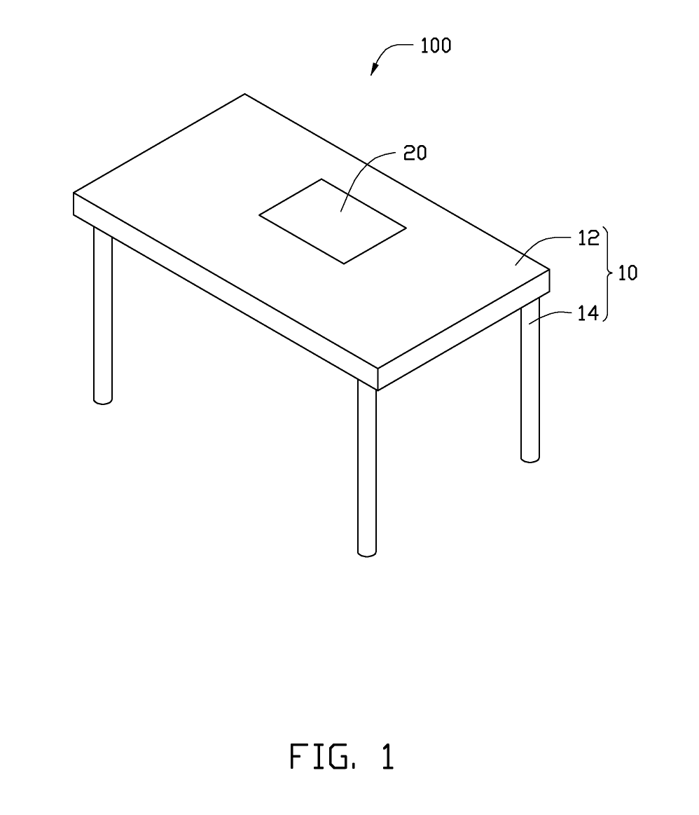

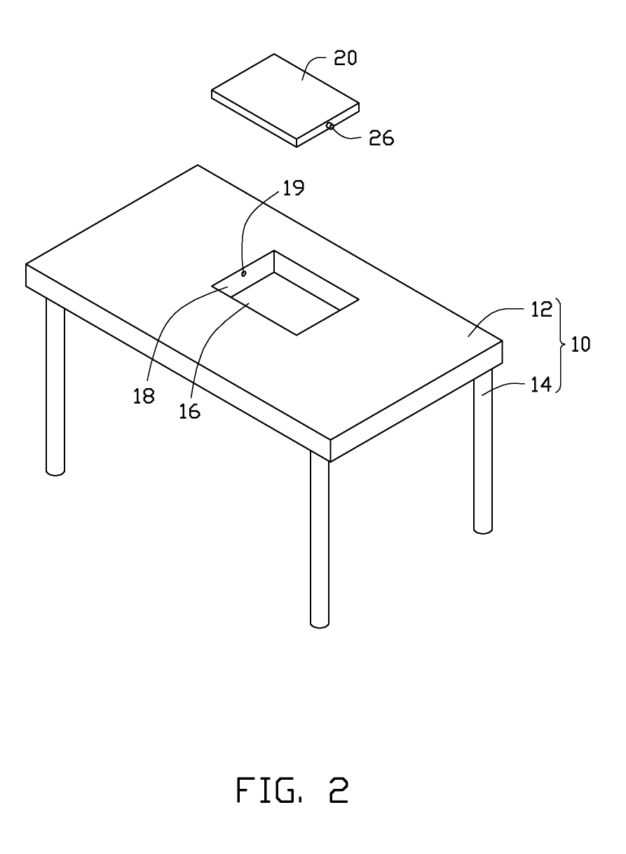

Referring to FIGS. 1-2, a computer desk assembly 100 includes a desk 10 and a display 20 mounted in the desk 10. The desk 10 includes a body 12 and four legs 14. The body 12 is rectangular-shaped. The body 12 defines a cavity therein to receive a power supply system (not shown) of the display 20. A center of the body 12 defines a rectangular receiving space 16 communicating a top surface with a bottom surface of the body 12. The receiving space 16 bounded with four side walls 18. Each of two opposite side walls 18 defines a pivot hole 19 therein.

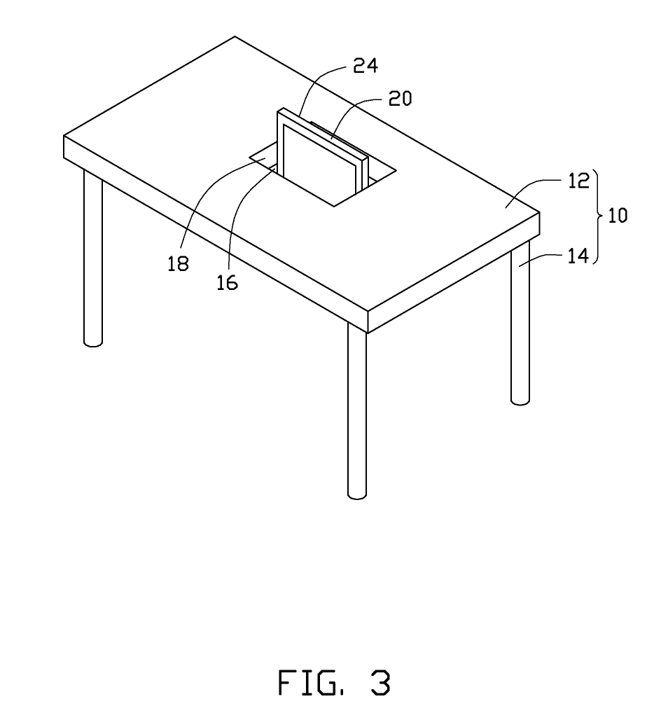

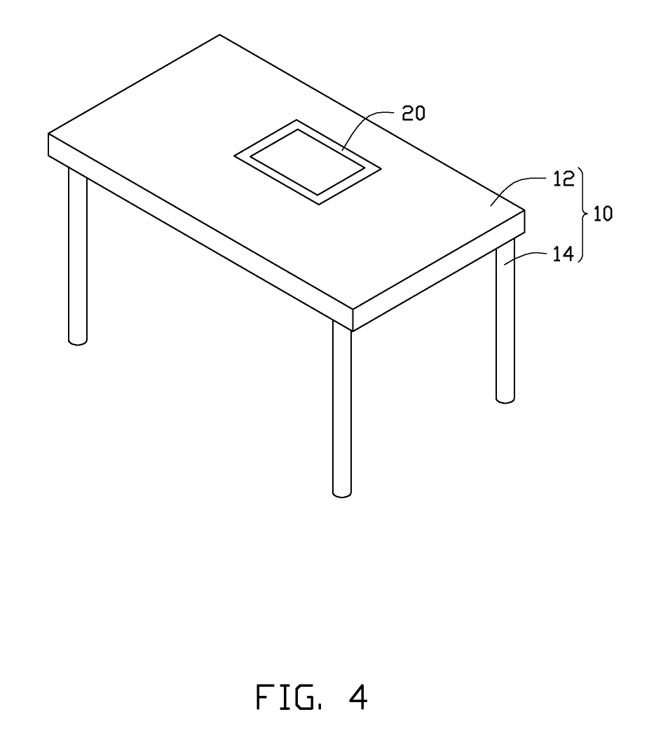

Referring also to FIGS. 3-4, the display 20 is received in the receiving space 16 of the desk 10 and is pivotably connected with the body 12. The display 20 may be a touch screen display. The display 20 has two pivot portions 26 respectively extending from opposite sides thereof corresponding to the pivot holes 19 in the receiving space 16. The display 20 is pivotably connected with the body 12 by the pivot portions 26 received in the pivot hole 19; thus, the display 20 can be rotated to face upwards or downwards with respect to the body 12. And a backside 24 can be decorated similar to a desktop of the desk 10 or may be configured to act as a desk blotter or writing board. Cables for connecting the display 20 to the power supply and the computer may be run through holes axially defined (not shown) in the pivot holes 19 and the pivot portions 26. In alternative embodiments the display 20 may instead be an all in one computer.

When the computer desk assembly 100 is in a first state, shown as FIG. 1, the display 20 is received in the receiving space 16 of the body 12. The backside 24 of the display 20 faces upwards and is coplanar with the desktop and frees up space on the desk 10 when a computer (not shown) connected to the display 20 is not in use. Since the backside 24 is coplanar with the top surface of the body 12, it can save space of the desk 10 and prevent the display 20 from dust pollution.

When the computer desk assembly 100 in a second state, shown in FIG. 4, the display 20 is in use. The display 20 is rotated 180 degrees relative to the body 12 around the pivot portions 26 thereby facing upwards and ready for use.

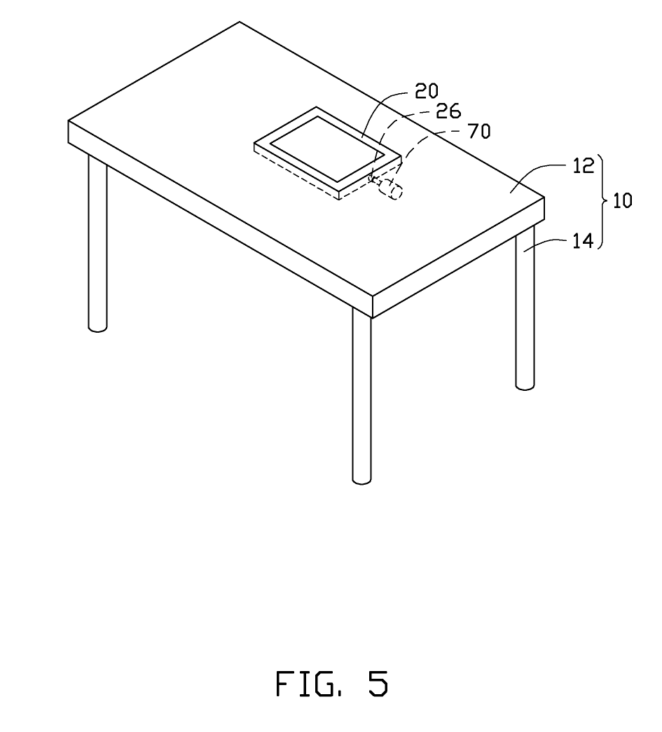

Alternatively, as shown in FIG. 5, the display 20 can automatically be rotated by a drive motor 70 activated by user action. The drive motor 70 drives the pivot portions 26 of the display 20 to rotate. In addition, the display 20 can define the pivot holes 19 and the body 12 can form the pivot portions 26 in the receiving space 16.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A computer desk assembly, comprising:
a desk defining a receiving space in a top thereof, the receiving space bounded with four side walls; and
a display in the receiving space of the desk and pivotably connected with two opposite side walls of the four sidewalls of the desk;
wherein when the computer desk assembly is in a first state, a backside of the display faces upwards and is coplanar with a desktop of the desk; and when the computer desk assembly is in a second state, the display is rotated relative to the desk to face upwards and ready for use.

2. The computer desk assembly of claim 1, wherein the display comprises two pivot portions pivotably engaged in the opposite side walls in the receiving space of the desk.

3. The computer desk assembly of claim 2, wherein the pivot portions respectively extends from two middle portions of two opposite ends.

4. The computer desk assembly of claim 2, further comprising a drive motor driving the pivot portions of the display to rotate.

5. The computer desk assembly of claim 1, wherein the display is a touch screen display.

6. The computer desk assembly of claim 1, wherein the screen is coplanar with a top surface of the desk in the second state.

7. The computer desk assembly of claim 1, wherein the receiving space communicates the top surface with a bottom surface of the desk.

8. A computer desk assembly assembly, comprising:
a desk defining a receiving space in a top thereof, the receiving space bounded with four side walls; and
a touch screen display in the receiving space of the desk and pivotably connected with two opposite side walls of the desk;
wherein when the computer desk assembly is in a first state, the touch screen display faces inwards of the desk; and when the computer desk assembly is in a second state, the touch screen display is rotated relative to the desk to face upwards and ready for use.

9. The computer desk assembly of claim 8, wherein the display comprises two pivot portions pivotably engaged in the opposite side walls in the receiving space of the desk.

10. The computer desk assembly of claim 9, wherein the pivot portions respectively extends from two middle portions of two opposite ends.

11. The computer desk assembly of claim 8, wherein the screen is coplanar with a top surface of the desk in the second state.

12. The computer desk assembly of claim 8, wherein the receiving space communicates the top surface with a bottom surface of the desk.
